(19) United States
(12) Patent Application Publication
(10) Pub. No.: US 2014/0112033 A1
(43) Pub. Date: Apr. 24, 2014

(54) POWER SUPPLY APPARATUS

(71) Applicant: FSP TECHNOLOGY INC., Taoyuan County (TW)

(72) Inventor: Yen-Chun Lin, Taoyuan County (TW)

(73) Assignee: FSP TECHNOLOGY INC., Taoyuan County (TW)

(21) Appl. No.: 14/059,464

(22) Filed: Oct. 22, 2013

(30) Foreign Application Priority Data
Oct. 24, 2012 (CN) 201210409169.3

(51) Int. Cl. H02H 7/125; H02M 1/44; H02M 7/04

(52) U.S. Cl. CPC H02H 7/125; H02M 7/04; H02M 1/44
USPC 363/44; 363/84; 363/52

(57) ABSTRACT

A power supply apparatus is provided, in which a control chip is used to detect an AC input power, so that it is unnecessary to additionally set an external independent detection circuit, by which not only a design cost is decreased, an extra standby loss is also avoided. Moreover, the method of using the control chip to execute detection of the AC input power can effectively decrease detection deviation, so as to notify the load system within an allowable (accurate) time (i.e. the predetermined time). Moreover, the control chip can determine and adjust the predetermined time within which the indication signal is generated to notify the load system according to an application requirement of the load system, so that the power supply apparatus can be generally applied in different types of the load systems having a timing control requirement.

### CROSS-REFERENCE TO RELATED APPLICATION

This application claims the priority benefit of China application Ser. No. 201210409169.3, filed on Oct. 24, 2012. The entirety of the above-mentioned patent application is hereby incorporated by reference herein and made a part of this specification.

### BACKGROUND

1. Technical Field

The invention relates to a power conversion technique. Particularly, the invention relates to a power supply apparatus applied to a load system having a timing control requirement.

2. Related Art

In some load systems having a timing control requirement, for example, a display system, when an alternating current (AC) input power (for example, city power) received by a power supply apparatus thereof is abnormal (for example, power off, power failure, disappeared), an external independent detection circuit is generally used to perform detection to notify the load system. In this way, once the load system receives the notification, the load system executes a normal shutdown procedure to prevent the system from unexpected power off or crash.

However, since the existing detection circuit used for detecting the AC input power has plenty of components, a larger hardware layout area and higher design cost are required. Moreover, the existing detection circuit used for detecting the AC input power has to be constantly connected to the AC input power, so that a system standby loss is increased. Moreover, since the existing detection circuit used for detecting the AC input power has higher detection deviation, it probably cannot notify the load system within an allowable (accurate) time, and cannot be generally applied in different types of the load systems having the timing control requirement.

### SUMMARY

Accordingly, the invention is directed to a power supply apparatus, which is capable of effectively resolving the problems mentioned in the related art.

An exemplary embodiment of the invention provides a power supply apparatus including a conversion circuit and a control chip, where the conversion circuit is configured to convert an AC input power to provide a DC output power to a load system. The control chip is coupled to the conversion circuit, and is configured to control an operation of the conversion circuit, and has a function of detecting the AC input power. When the control chip detects that the AC input power is abnormal, the control chip generates an indication signal within a predetermined time to notify the load system.

In an exemplary embodiment of the invention, the control chip includes a control body and an indication unit. The control body is used for controlling the operation of the conversion circuit, and detecting the AC input power. The indication unit is coupled to the control body, and determines whether to generate the indication signal within the predetermined time in response to detection of the AC input power performed by the control body.

In an exemplary embodiment of the invention, the control body detects the AC input power through a high-voltage (HV) pin, a brown-in & brown-out pin, a discharge function pin, an input voltage (Vac) sense pin or combinations thereof

In an exemplary embodiment of the invention, when the control body detects that the AC input power is abnormal, the control body controls the indication unit to generate the indication signal within the predetermined time, and when the control body detects that the AC input power is not abnormal (i.e. normal), the control body controls the indication unit to stop generating the indication signal.

In an exemplary embodiment of the invention, the indication unit may include a delay unit or a counter unit.

In an exemplary embodiment of the invention, the predetermined time is determined according to an application requirement of the load system. Therefore, the predetermined time is adjustable.

In an exemplary embodiment of the invention, the conversion circuit is a pulse width modulation (PWM)-based conversion circuit, and accordingly a topology type of the PWM-based conversion circuit at least includes a power factor correction power conversion topology, a flyback power conversion topology, an LLC resonant power conversion topology, a buck power conversion topology, a buck-boost power conversion topology, a Cuk power conversion topology or combinations thereof

In an exemplary embodiment of the invention, the PWM-based conversion circuit at least includes a rectification-filtering unit and a conversion unit. The rectification-filtering unit is used for receiving the AC input power, and rectifying and filtering the AC input power. The conversion unit is coupled to the rectification-filtering unit, and converts an output of the rectification-filtering unit under control of the control chip, so as to generate the DC output power. In this way, the control body is coupled to an input or an output of the rectification-filtering unit to detect the AC input power.

In an exemplary embodiment of the invention, the load system executes a normal shutdown procedure in response to the indication signal, and the load system at least includes a display system.

According to the above description, the power supply apparatus of the invention is applied in a load system having the timing control requirement, and the control chip in the power supply apparatus is used to detect the AC input power, so that it is unnecessary to additionally set an external independent detection circuit (in case that the control chip has the function of detecting the AC input power). In this way, not only a design cost is decreased, an extra standby loss is also avoided.

On the other hand, the method of using the control chip to execute detection of the AC input power can effectively decrease detection deviation, so as to notify the load system within an allowable (accurate) time (i.e. the predetermined time).

Moreover, the control chip can determine and adjust the predetermined time within which the indication signal is generated to notify the load system according to an application requirement of the load system, so that the power supply apparatus can be generally applied in different types of the load systems having the timing control requirement.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a power supply apparatus 10 according to an exemplary embodiment of the invention.

FIG. 2A is a schematic diagram of an implementation of a conversion circuit 101 of FIG. 1.

FIG. 2B is a schematic diagram of another implementation of the conversion circuit 101 of FIG. 1.

FIG. 2C is a schematic diagram of still another implementation of the conversion circuit 101 of FIG. 1.

FIG. 3 is a schematic diagram of an implementation of a control chip 103 of FIG. 1.

FIG. 4A is a schematic diagram illustrating a situation that a control body 301 detects an AC input power AC_IN according to an exemplary embodiment of the invention.

FIG. 4B is a schematic diagram illustrating a situation that the control body 301 detects the AC input power AC_IN according to another exemplary embodiment of the invention.

FIG. 4C is a schematic diagram illustrating a situation that the control body 301 detects the AC input power AC_IN according to still another exemplary embodiment of the invention.

FIG. 5A is a schematic diagram of an implementation of an indication unit 303 of FIG. 3.

FIG. 5B is a schematic diagram of another implementation of the indication unit 303 of FIG. 3.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

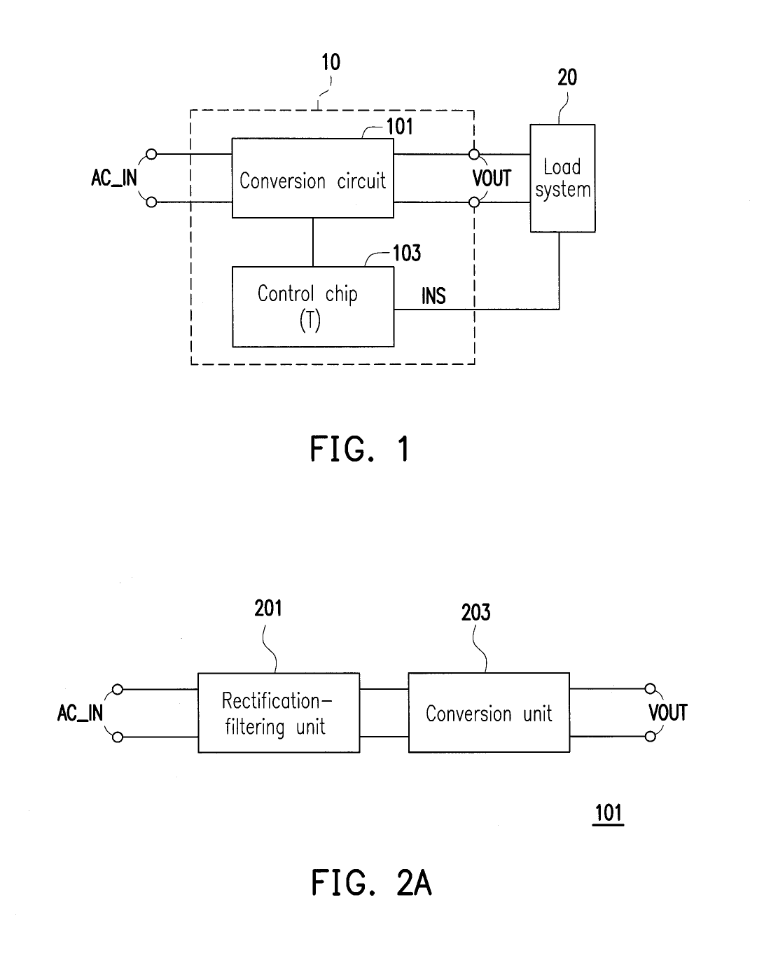

FIG. 1 is a schematic diagram of a power supply apparatus 10 according to an exemplary embodiment of the invention. Referring to FIG. 1, the power supply apparatus 10 is applied in a load system 20 (for example, a display system, though the invention is not limited thereto) having a time control requirement, and the power supply apparatus 10 of the exemplary embodiment may include a conversion circuit 101 and a control chip 103.

The conversion circuit 101 is used for converting (i.e. performing an AC-to-DC conversion on) an AC input power (for example, city power, though the invention is not limited thereto) AC_IN, so as to provide a DC output power VOUT to the load system 20.

Moreover, the control chip 103 is coupled to the conversion circuit 101. The control chip 103 is used for controlling an operation of the conversion circuit 101, and has a function of detecting the AC input power AC_IN. In the present exemplary embodiment, when the control chip 103 detects that the AC input power AC_IN is abnormal (for example, power off, power failure, or disappeared, though the invention is not limited thereto), the control chip 103 generates an indication signal INS within a predetermined time T to notify the load system 20. In this way, the load system 20 executes a normal shutdown procedure in response to the indication signal INS come from the control chip 103. In the present exemplary embodiment, the indication signal

INS generated by the control chip 103 can be a logic high-level signal, a logic low-level signal or an open collector signal, though the invention is not limited thereto. Moreover, according to an actual application/design requirement, the generated indication signal INS can be inverted for transmitting to the load system 20.

In detail, the conversion circuit 101 can be a pulse width modulation (PWM)-based conversion circuit. In this case, a topology type of the PWM-based conversion circuit 101 can be a power factor correction (PFC) power conversion topology, a flyback power conversion topology, an LLC resonant power conversion topology, a buck power conversion topology, a buck-boost power conversion topology, a Cuk power conversion topology or combinations thereof (for example, PFC+LLC power conversion topology, PFC+flyback power conversion topology, etc., though the invention is not limited thereto).

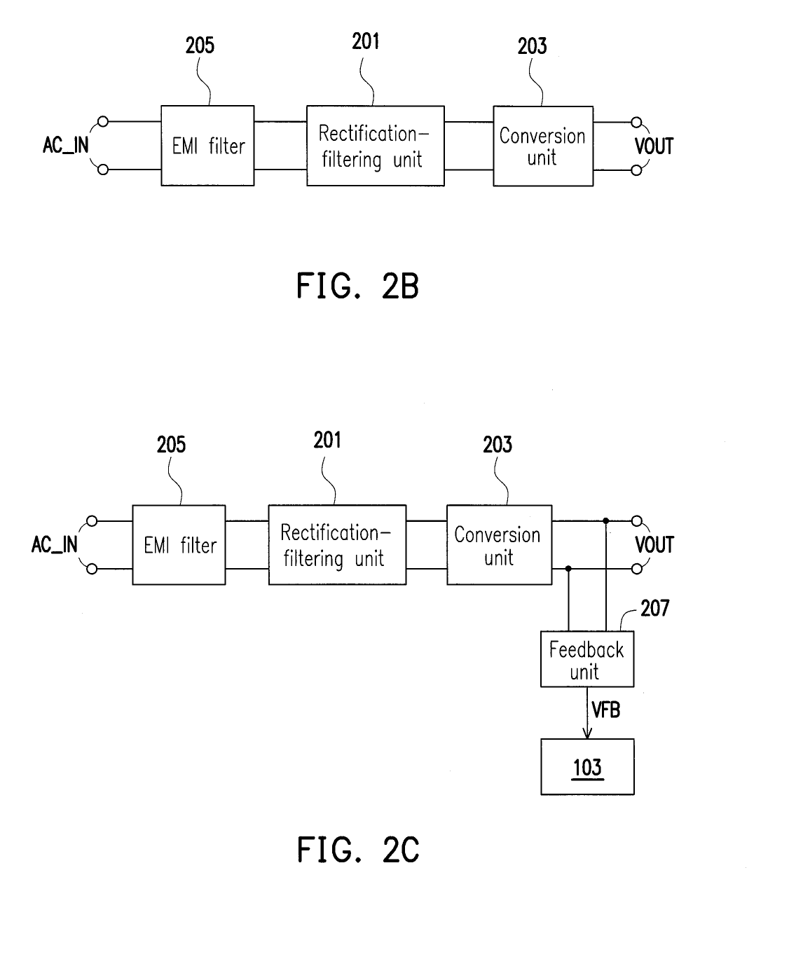

Regardless of the topology of the conversion circuit 101, it generally includes a rectification-filtering unit 201 and a conversion unit 203 as that shown in FIG. 2A. FIG. 2A is a schematic diagram of an implementation of the conversion circuit 101 of FIG. 1. The rectification-filtering unit 201 is used for receiving the AC input power AC_IN, and rectifying and filtering the received AC input power AC_IN. In the present exemplary embodiment, the rectification-filtering unit 201 can be implemented by a combination of a full-bridge rectifier and a filtering capacitor, or a combination of a half-bridge rectifier and a filtering capacitor, though the invention is not limited thereto, and implementation of the rectification-filtering unit 201 is determined according to an actual design requirement.

Moreover, the conversion unit 203 is coupled to the rectification-filtering unit 201, and converts (i.e. performs a DC-AC-DC conversion on) an output of the rectification-filtering unit 201 in response to the control (i.e. PWM control) of the control chip 101, so as to generate and output the DC output power VOUT to the load system 20.

FIG. 2B is a schematic diagram of another implementation of the conversion circuit 101 of FIG. 1, in which an electromagnetic interference (EMI) filter 205 is configured between the AC input power AC_IN and the rectification-filtering unit 201 for eliminating EMI of the AC input power ACIN, or preventing the power supply apparatus 10 from influencing a public power grid network supplying the AC input power AC_IN.

FIG. 2C is a schematic diagram of still another implementation of the conversion circuit 101 of FIG. 1, in which the conversion circuit 101 further includes a feedback unit 207 configured at an output side of the conversion unit 203, which may adopt a voltage-dividing feedback method or a photo-coupling feedback method for providing a feedback signal VFB related to the DC output power VOUT to the control chip 103. In this way, the control chip 103 can accordingly adjust and stabilize the output of the conversion unit 203.

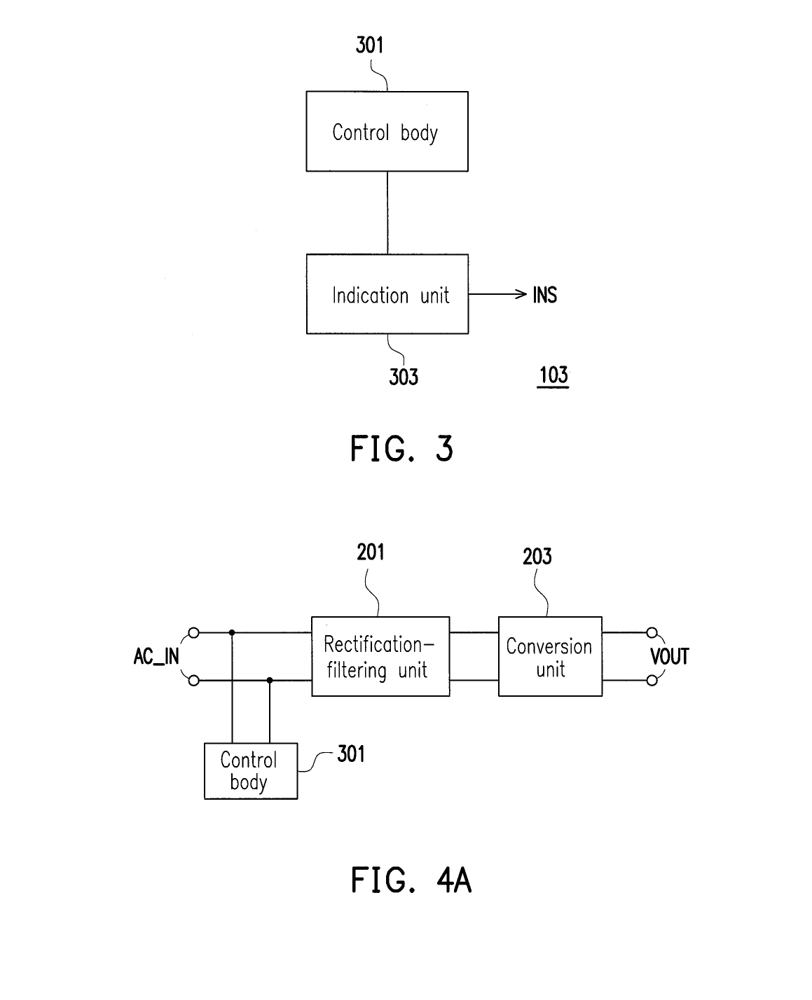

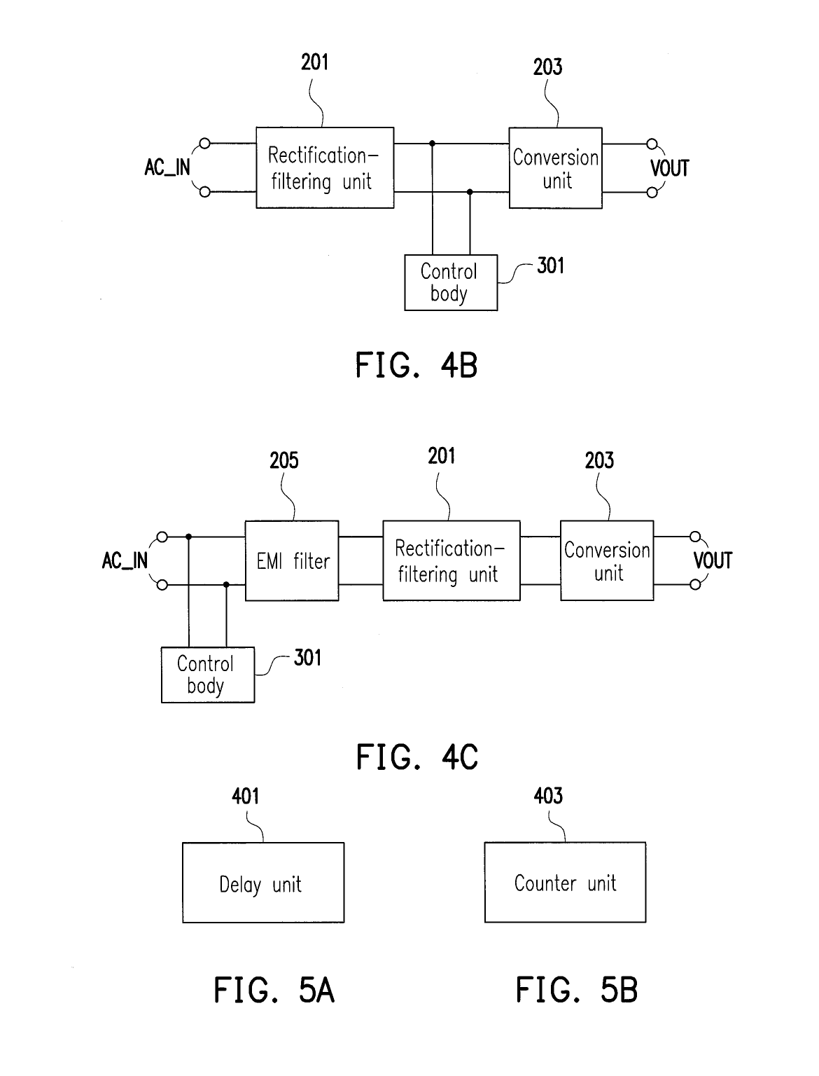

On the other hand, the control chip 103 may include a control body 301 and an indication unit 303, as that shown in FIG. 3. FIG. 3 is a schematic diagram of an implementation of the control chip 103 of FIG. 1. The control body 301 is used for controlling the operation of the PWM-based conversion circuit 101 (i.e. the operation of the conversion unit 203), and detecting the AC input power AC_IN. In the present exemplary embodiment, the control body 301 can be coupled to the input (shown in FIG. 4A) or the output (shown in FIG. 4B) of the rectification-filtering unit 201 for detecting the AC input power ACJN, though the invention is not limited thereto. In detail, considering that the conversion circuit 101 has the EMI filter 205, the control body 301 can also be coupled to the input (shown in FIG. 4C) of the EMI filter 205 for detecting the AC input power AC_IN. In other words, the control body 301 can be coupled to the input or output of the rectification-filtering unit 201 or coupled to the input of the EMI filter 205 according to an actual hardware design requirement of the power supply apparatus 10 for detecting the AC input power AC_IN.

Moreover, in the present exemplary embodiment, the control chip 103 itself is used to execute detection of the AC input power AC_IN, and in case that the control chip 103 itself has the function (for example, a high-voltage (HV) pin, a brown-in & brown-out pin, a discharge function pin, or an input voltage (Vac) sense pin) of detecting the AC input power AC_IN, the control body 301 can detect the AC input power AC_IN through the high-voltage (HV) pin, the brown-in & brown-out pin, the discharge function pin, the Vac sense pin or combinations thereof (for example, HV pin+brown-in & brown-out pin, HV pin+brown-in & brown-out pin+discharge function pin, etc.), though the invention is not limited thereto.

In detail, the aforementioned HV pin, brown-in & brown-out pin, discharge function pin and Vac sense pin are all pins set/configured on the control chip 103, and are all connected to the AC input power AC_IN, where an original function of the HV pin in the control chip 103 is to provide a start power for turning on the control chip 103 for the first time, an original function of the brown-in & brown-out pin in the control chip 103 is to set a power on voltage and a power off voltage, an original function of the discharge function pin in the control chip 103 is to discharge the capacitor (X-cap) after power off, and an original function of the Vac sense pin in the control chip 103 is to detect the AC input power AC_IN. Therefore, as long as any pin of the control chip 103 is connected to the AC input power AC_IN, such pin can be used in collaboration with the control body 301 to detect the AC input power AC_IN.

Moreover, the indication unit 303 is coupled to the control body 301, and determines whether to generate the indication signal INS to the load system 20 within the predetermined time T according to detection of the AC input power AC_IN performed by the control body 301. In the present exemplary embodiment, when the control body 301 detects that the AC input power AC_IN is abnormal (power off, power failure, or disappeared, though the invention is not limited thereto), the control body 301 controls the indication unit 303 to generate the indication signal INS to the load system 20 within the predetermined time T. Conversely, when the control body 301 detects that the AC input power AC_IN is not abnormal (i.e. normal, or in other words, the AC input power AC_IN is normally supplied), the control body 301 controls the indication unit 303 to stop generating the indication signal INS to the load system 20.

The indication unit 303 embedded in the control chip 103 can be implemented by a delay unit 401 shown in FIG. 5A or implemented by a counter unit 403 shown in FIG. 5B, though the invention is not limited thereto, and implementation of the indication unit 303 is determined according to an actual application/design requirement. In this case, the aforementioned predetermined time T can be determined according to an application requirement of the load system 20 (since timing control requirements of different load systems are different), and the predetermined time T is adjustable.

In detail, once the control body 301 detects that the AC input power AC_IN is abnormal (power off, power failure, or disappeared), the control body 301 can generate the indication signal INS to the load system 20 within the predetermined time

T through a predetermined delay time of the delay unit 401, or generate the indication signal INS to the load system 20 within the predetermined time T through a predetermined counting time of the counter unit 403.

Certainly, in other exemplary embodiments, an external passive component (for example, a capacitor or a resistor) can be connected to a predetermined pin of the control chip 103 to determine or adjust the predetermined time T (for example, to change a resistance of the external resistor, or change a capacitance of the external capacitor). Therefore, implementation of the indication unit 303 is determined according to an actual application/design requirement, which is not limited by the aforementioned embodiments.

Therefore, the power supply apparatus 10 of the invention can be applied to any load system 20 (for example, a display system, a computer system, etc.) having the timing control requirement, in which the control chip 103 itself is used to detect the AC input power AC_IN, so that it is unnecessary to additionally set an external independent detection circuit (in case that the control chip 103 has the function of detecting the AC input power AC_IN, for example, to detect the AC input power AC_IN through the HV pin; or detect the AC input power AC_IN through the brown-in & brown-out pin; or detect the AC input power AC_IN through the discharge function pin; or detect the AC input power AC_IN through the Vac sense pin, though the invention is not limited thereto). In this way, not only a design cost is decreased, an extra standby loss is also avoided.

On the other hand, the method of using the HV pin, the brown-in & brown-out pin, the discharge function pin, or the Vac sense pin of the control chip 103 to execute detection of the AC input power AC_IN can effectively decrease detection deviation, so as to notify the load system 20 within an allowable (accurate) time (i.e. the predetermined time T). Moreover, the control chip 103 can determine and adjust the predetermined time T within which the indication signal INS is generated to notify the load system 20 according to an application requirement of the load system 20, so that the power supply apparatus can be generally applied in different types of the load systems having the timing control requirement (display system, computer system, etc.).

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power supply apparatus, comprising:
a conversion circuit, configured to convert an AC input power to provide a DC output power to a load system;
a control chip, coupled to the conversion circuit, configured to control an operation of the conversion circuit, and having a function of detecting the AC input power,
wherein when the control chip detects that the AC input power is abnormal, the control chip generates an indication signal within a predetermined time to notify the load system.

2. The power supply apparatus as claimed in claim 1, wherein the control chip comprises:
a control body, configured to control the operation of the conversion circuit, and detect the AC input power; and
an indication unit, coupled to the control body, and determining whether to generate the indication signal within the predetermined time in response to detection of the AC input power performed by the control body.

3. The power supply apparatus as claimed in claim 2, wherein the control body detects the AC input power through a high-voltage pin, a brown-in & brown-out pin, a discharge function pin, an input voltage (Vac) sense pin or combinations thereof.

4. The power supply apparatus as claimed in claim 2, wherein:
when the control body detects that the AC input power is abnormal, the control body controls the indication unit to generate the indication signal within the predetermined time, and
when the control body detects that the AC input power is normal, the control body controls the indication unit to stop generating the indication signal.

5. The power supply apparatus as claimed in claim 2, wherein the indication unit comprises a delay unit or a counter unit.

6. The power supply apparatus as claimed in claim 5, wherein the predetermined time is determined according to an application requirement of the load system.

7. The power supply apparatus as claimed in claim 6, wherein the predetermined time is adjustable.

8. The power supply apparatus as claimed in claim 2, wherein the conversion circuit is a pulse width modulation (PWM)-based conversion circuit.

9. The power supply apparatus as claimed in claim 8, wherein a topology type of the PWM-based conversion circuit at least includes a power factor correction power conversion topology, a flyback power conversion topology, an LLC resonant power conversion topology, a buck power conversion topology, a buck-boost power conversion topology, a Cuk power conversion topology or combinations thereof.

10. The power supply apparatus as claimed in claim 8, wherein the PWM-based conversion circuit at least comprises:
a rectification-filtering unit, receiving the AC input power, and rectifying and filtering the AC input power; and
a conversion unit, coupled to the rectification-filtering unit, and converting an output of the rectification-filtering unit under control of the control chip, so as to generate the DC output power.

11. The power supply apparatus as claimed in claim 10, wherein the control body is coupled to an input or an output of the rectification-filtering unit to detect the AC input power.

12. The power supply apparatus as claimed in claim 10, wherein the PWM-based conversion circuit further comprises:
an electromagnetic interference (EMI) filter, coupled between the AC input power and the rectification-filtering unit.

13. The power supply apparatus as claimed in claim 12, wherein the control body is coupled to an input of the EMI filter to detect the AC input power.

14. The power supply apparatus as claimed in claim 10, wherein the PWM-based conversion circuit further comprises:
a feedback unit, coupled to an output of the conversion unit, and providing a feedback signal related to the DC output power to the control chip, such that the control chip adjusts and stabilizes the output of the conversion unit according to the feedback signal.

15. The power supply apparatus as claimed in claim 1, wherein the load system executes a normal shutdown procedure in response to the indication signal.

16. The power supply apparatus as claimed in claim 14, wherein the load system at least comprises a display system.
